(19) United States
(12) Patent Application Publication
(10) Pub. No.: US 2008/0292745 A1
(43) Pub. Date: Nov. 27, 2008

(54) Mold Structure and Method of Manufacture Thereof

(75) Inventor: Ralf Hubert SHMITZ, Hulzweiler (DE)

Correspondence Address: HUSKY INJECTION MOLDING SYSTEMS, LTD;CO/AMC INTELLECTUAL PROPERTY GRP, 500 QUEEN ST. SOUTH, BOLTON, ON, L7E 5S5, CA

(73) Assignee: HUSKY INJECTION MOLDING SYSTEMS LTD., Bolton (CA)

(21) Appl. No.: 11/752,332

(22) Filed: May 23, 2007

(51) Int. Cl. B29C 35/16

(52) U.S. Cl. 425/547; 164/36; 425/556; 425/588

(57) ABSTRACT

Disclosed are a mold gate insert as well as a mold assembly and an injection molding machine incorporating such a mold gate insert. The mold gate insert comprises a base structure formed of a wear resistant material having a first thermal conductivity. The base structure defines a mold cavity, at least in part, a nozzle assembly alignment portion for aligning a nozzle assembly with respect to the base structure, and a gate for communication between the mold cavity and the nozzle assembly. The mold gate insert further comprises a heat dam being completely enclosed by the base structure. The heat dam is made of a material having a second thermal conductivity being less than the first thermal conductivity and arranged within the base structure in proximity to the nozzle assembly alignment portion such that the heat flow between the nozzle assembly and the base structure is impeded. Furthermore, a method of producing the mold gate insert is disclosed.

### TECHNICAL FIELD OF THE INVENTION

The present invention generally relates to a mold structure and more specifically the present invention relates to a mold gate insert, a mold assembly, and an injection molding machine including such a mold gate insert. Furthermore, the present invention relates to a method of producing such a mold gate insert.

### BACKGROUND OF THE INVENTION

Injection molding machines are well known and commonly used to produce a wide variety of molded articles (such as, for example, plastic articles). Generally, a material, such as a plastic resin in the form of pellets, is fed to the machine through a hopper, and thence to a plasticizer where it is melted. The resin then flows under pressure to a nozzle, is injected through a gate into a mold cavity, cooled to its “freezing” temperature, and ejected from the mold cavity to complete a single molding cycle.

One area in which improvements can be made in the injection molding field is reducing the cycle time, thereby increasing the number of articles that can be produced by an injection molding machine. The cycle time for the injection molding machine is determined by a number of interdependent factors, including the physical and chemical attributes of the resin, the size of the molded article, and the time the molded article cools in a mold before it is ejected.

As is apparent, reducing the time needed to cool the article in the mold will reduce the overall cycle time. However, undesirable physical defects often result from attempts to reduce the cooling time, particularly in molded articles, such as preforms, made from polyethylene teraphthalate (PET). The most common of these undesirable characteristics are gate defects that occur in that portion of the preform in the vicinity of the gate. These common defects include crystalline halos and plugs, gate voids, internal dimples, scarred gates, and sticky or stringy gates. Many variables affect the quality of the gate area in a finished preform. Processing parameters, such as mold gate timing, nozzle tip temperature, and the flow rate of cooling fluid can all be adjusted to improve preform quality. However, insufficiently rapid heat transfer at the gate area remains one of the most persistent problems to overcome, and a continuing obstacle to greatly improved cycle times.

In a typical hot runner injection molding system with valve gating, insufficient cooling in the gate area can be attributed to several competing functions of the gate area, and the cyclic temperature swings to which it is subject. The gate is a passage, generally a tapered hole formed in a gate insert that directs the flow of resin from the nozzle to the mold cavity. The mold gate insert acts as a locator for the nozzle tip on one side, and forms part of the mold cavity at its other side. Its nozzle side is subject to a constant high nozzle tip temperature that can be undesirably transferred through the insert to the mold cavity. Meanwhile, the mold cavity side of the gate insert must quickly cycle between a high temperature when the gate is open to a low temperature sufficient to freeze the resin when the mold has been filled and the gate closed. In order to lower the cycle time of the injection molding apparatus, it is desirable to thermally isolate the mold cavity from the nozzle tip.

Several prior art references disclose thermal shielding at the nozzle tip to limit cooling of the hot runner nozzle tip in the vicinity of the mold gate area. For example, the commonly owned U.S. Pat. No. 6,220,850 discloses a mold gate insert that is formed of two pieces. A first portion of the insert forms a gate land and is made of an insulating material to thermally shield the nozzle. The second portion of the insert forms a section of the mold cavity and is made of a highly thermally conductive material. During the cooling phase of the injection cycle, the second portion provides rapid dissipation of heat to cool the mold cavity, while the first portion creates a thermal barrier to shield the nozzle tip from the cooling of the second portion.

The commonly owned U.S. Pat. No. 5,879,727 discloses a thermal insulating element provided between a nozzle tip and a mold insert. The thermal insulating element limits the heat loss from the nozzle tip to the gate insert.

U.S. Pat. No. 7,025,585 discloses a mold gate insert with a mold gate insert body, which is comprised of a material having a high thermal conductivity, and a thermal insulation element, which is nested in the mold gate insert body. The thermal insulation element is provided to abut a nozzle seal and align the nozzle with a mold gate.

While the above mold gate inserts including a thermal insulation element provide thermal shielding to the nozzle tip, these mold gate inserts nevertheless can lead to certain problems for the following reason. Due to the high pressures and temperatures present in the vicinity of the mold gate insert, the thermal insulation element thereof, which often is made of ceramic material, can break. Such breaking of the thermal insulation element in conventional mold gate inserts not only can lead to a reduction of the thermal shielding properties thereof, but also to a malfunction of the mold gate insert itself. This is because, in conventional mold gate inserts the thermal insulation element contributes to the necessary alignment and sealing of the nozzle assembly provided by such inserts. Obviously, conventional mold gate inserts with a broken thermal insulation element cannot provide for the necessary alignment and sealing of the nozzle and, thus, have to be replaced.

### SUMMARY OF THE INVENTION

According to a first aspect of the present invention, there is provided a mold gate insert comprising a base structure formed of a wear resistant material having a first thermal conductivity. The base structure defines a mold cavity, at least in part, a nozzle assembly alignment portion for aligning a nozzle assembly with respect to the base structure, and a gate for communication between the mold cavity and the nozzle assembly. The mold gate insert further comprises a heat dam being completely enclosed by the base structure. The heat dam is made of a material having a second thermal conductivity being less than the first thermal conductivity and arranged within the base structure in proximity to the nozzle assembly alignment portion such that the heat flow between the nozzle assembly and the base structure is impeded.

The mold gate insert according to embodiments of the present invention has, amongst others, the advantage that whereas in conventional mold gate inserts the thermal insulation elements tend to break due the extreme ambient conditions and, thus, lead to a failure of the mold gate insert itself, the heat dam of the mold gate insert according to embodiments of the present invention is not directly exposed to the high pressures and temperatures present in the vicinity of the mold gate insert and, thus, less prone to break. Furthermore, even in case the heat dam of the mold gate insert according to embodiments of the present invention should break, the mold gate insert according to embodiments of the present invention, contrary to conventional mold gate inserts, still can provide for the required alignment and sealing of the nozzle assembly. This is because, these functions are provided by the base structure of the mold gate insert according to embodiments of the present invention.

In a further aspect of the present invention, there is provided a mold assembly for an injection molding machine, including a mold gate insert. The mold assembly has a mold cavity and a mold core that cooperate to form a molded plastic article when molten plastic resin is injected into the mold cavity during an injection cycle. A gate permits the resin to flow into the mold cavity from the nozzle tip of a nozzle assembly. The gate is formed in the base structure of the mold gate insert. The base structure is made of a material having a first high thermal conductivity and defines a part of the mold cavity, and a nozzle assembly alignment portion for aligning the nozzle assembly with respect to the base structure. The mold gate insert further comprises a heat dam being completely enclosed by the base structure. The heat dam is made of a material having a second thermal conductivity being less than the first thermal conductivity and arranged within the base structure in proximity to the nozzle assembly alignment portion such that the heat flow between the nozzle assembly and the base structure is impeded. The base structure permits heat to be rapidly removed during the cooling phase of the injection cycle, while the heat dam simultaneously shields the nozzle tip from the cooling effect. A conventional stripping means is then provided to strip the cooled molded article from the mold cavity.

In a yet further aspect of the present invention, there is provided an injection molding machine employing a mold gate insert that can decrease the cycle time for the machine. The injection molding machine has multiple mold cavities, each of which is served by a separate nozzle assembly conveying molten plastic resin to a nozzle tip for injection into its respective mold cavity. In a single injection cycle, the gates to each mold cavity are opened to permit the resin to flow into the mold cavity. When the cavity is filled, the gates are closed, thereby stopping the flow of resin to the cavity. The mold cavity is then cooled to freeze the resin and a finished plastic article is ejected. The gate is formed in the base structure of the mold gate insert. The base structure is made of a material having a first high thermal conductivity and defines a part of the mold cavity, and a nozzle assembly alignment portion for aligning the nozzle assembly with respect to the base structure. The mold gate insert further comprises a heat dam being completely enclosed by the base structure. The heat dam is made of a material having a second thermal conductivity being less than the first thermal conductivity and arranged within the base structure in proximity to the nozzle assembly alignment portion such that the heat flow between the nozzle assembly and the base structure is impeded. During the cooling phase of the injection cycle, the base structure provides rapid dissipation of heat to cool the mold cavity, while the heat dam creates a thermal barrier to shield the nozzle tip from the cooling of the base structure.

In a yet further aspect of the present invention there is provided a method for producing a mold gate insert including a base structure formed of a wear resistant first material having a first thermal conductivity and a heat dam being made of a second material having a second thermal conductivity being less than the first thermal conductivity. The method comprises the steps of: providing a wax model of the base structure, wherein the second material of the heat dam is completely enclosed by the wax model of the base structure; coating the wax model of the base structure with a ceramic shell; hardening the ceramic shell of the wax model of the base structure; replacing the wax of the wax model of the base structure within the ceramic shell by the molten first material, which thereby completely encloses the second material of the heat dam; and solidifying the molten first material within the ceramic shell of the base structure and removing the ceramic shell.

### DESCRIPTION OF THE DRAWINGS

A better understanding of the embodiments of the present invention (including alternatives and/or variations thereof) may be obtained with reference to the detailed description of the embodiments along with the following drawings, in which:

FIG. 1 is a cross sectional view of a portion of a hot runner system of an injection molding machine;

FIG. 2 is a cross sectional view of a mold gate area of an injection molding machine, including a mold gate insert in accordance with the present invention;

FIG. 3 is a perspective view, partially cut away, of a mold gate insert as shown in FIG. 2; and

FIG. 4 is a cross sectional view of a mold assembly, including a mold gate insert in accordance with the present invention.

### DETAILED DESCRIPTION OF EMBODIMENTS

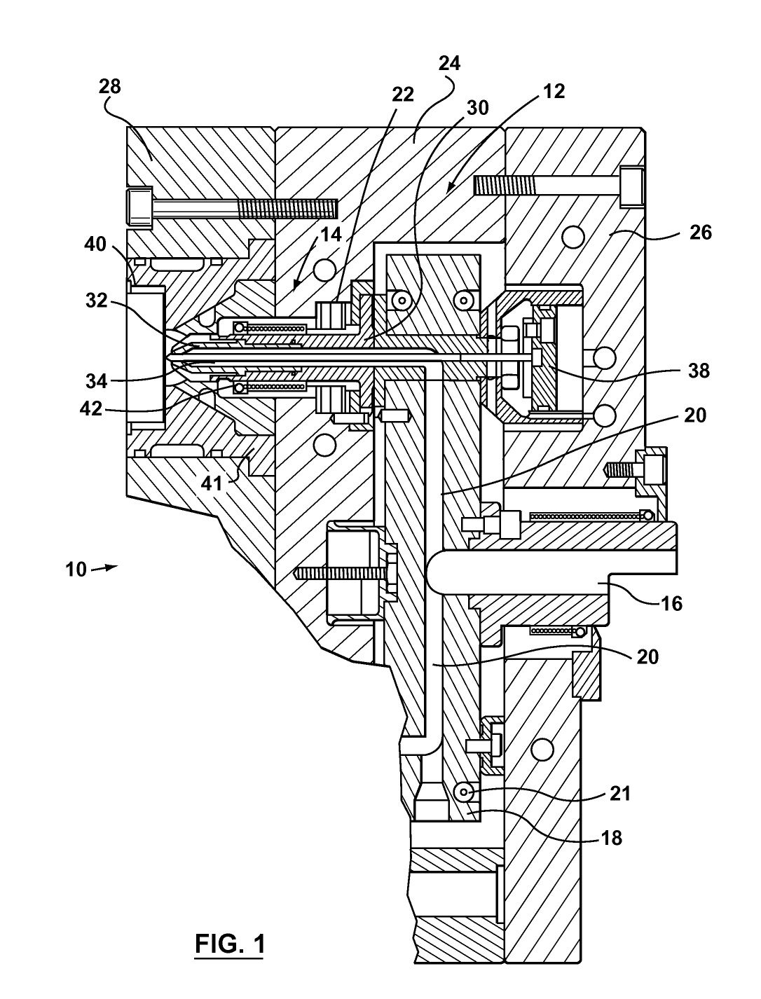

FIG. 1 shows a cross section of a portion of a multi-cavity injection molding machine, generally designated as 10, including a hot runner system 12. Hot runner system 12 provides molten plastic resin to a plurality of nozzle assemblies, one of which is shown and generally designated as 14. It is contemplated that embodiments of the present invention can be applied to injection molding machines that produce polyethylene teraphthalate (PET) preforms. As is well understood by those of skill in the art, PET is especially sensitive to uneven cooling effects that can result in crystallinity and other physical defects. However, the present invention is not limited to an injection molding machine 10 as shown in the Figures. The person skilled in the art will appreciate that embodiments of the present invention are applicable to other types of molding systems, such as, but not limited to, plastic injection molding system, plastic compression molding systems, metal molding systems and the like. It should be further understood that embodiments of the present invention are applicable to the molding systems incorporating any multicavitation mold, including PET molds, thin wall articles molds, closures molds and the like.

Molten plastic resin is supplied to hot runner system 12 from a resin source, typically a hopper feeding resin pellets to a plasticizer (not shown) and thence to a main melt channel 16. Main melt channel 16 conveys the now resin to a manifold 18. As is well known, manifold 18 has a number of manifold melt channels 20 through which the resin travels to nozzle assemblies 14 while it is maintained at an optimum processing temperature by manifold heaters 21.

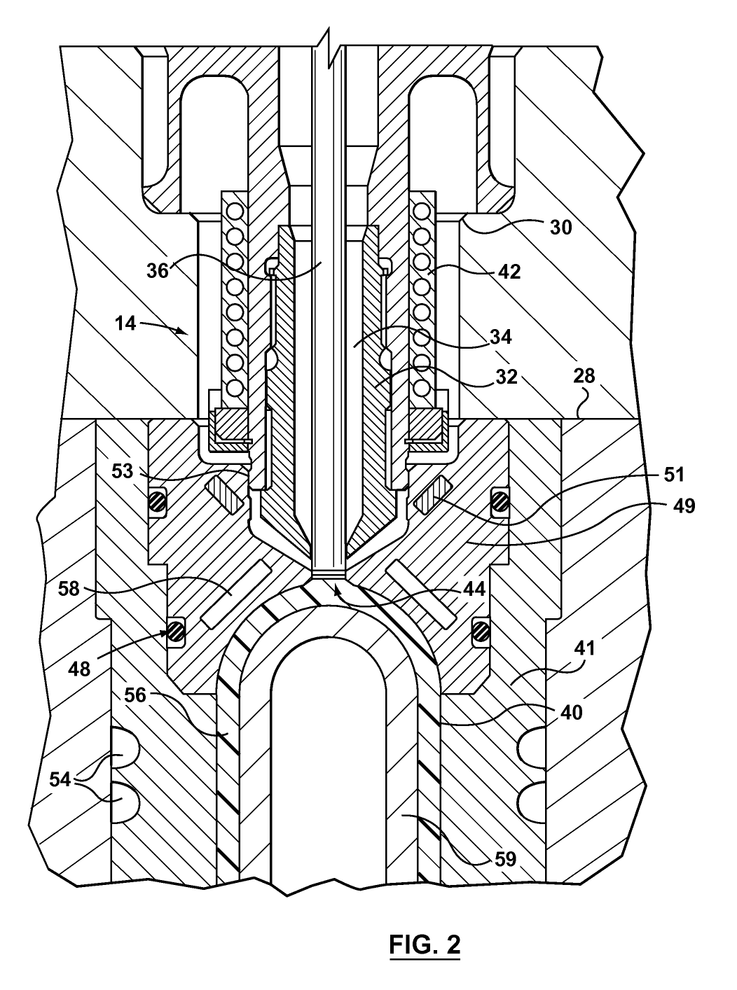

Nozzle assembly 14 is positioned within a bore 22 provided in a manifold plate 24, sandwiched between a manifold backing plate 26 and a cavity plate 28. Nozzle assembly 14 generally includes a nozzle housing 30 in which is held a nozzle tip 32 through which runs a nozzle channel 34 communicating with manifold melt channel 20. A valve stem 36 (see FIG. 2) is located within nozzle channel 34 and can be reciprocated by a piston 38 between an opened and a closed position. In the open position, the resin flows into a mold cavity 40 formed in a cavity member 41 located in cavity plate 28. In the closed position, as shown, the valve stem 36 is forced against a gate 44 (see FIG. 2) to restrict the flow of resin from the nozzle tip 32 and prevent the flow of resin into the mold cavity 40. A nozzle heater band 42 maintains nozzle tip 32 at a desired temperature determined by the resin being injected. For example, in an injection molding machine for molding polyethylene teraphthalate (PET) preforms, the nozzle tip 32 temperature can be maintained in the range of about 280° C. to 320° C.

Referring to FIG. 2, a cross section of a portion of injection molding machine 10 surrounding nozzle assembly 14 is shown. Nozzle assembly 14 is shown in a closed position, with valve stem 36 seated in gate 44, thereby sealing the gate 44 and preventing the flow of resin into mold cavity 40. Gate 44 is a passage that is defined in a mold gate insert 48 and that provides an entry point for the resin in a mold.

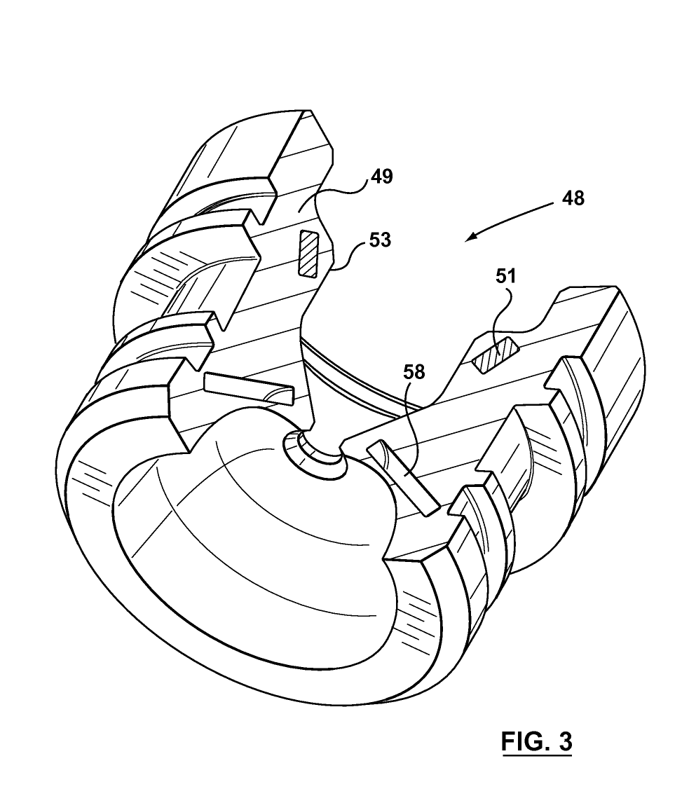

The construction of mold gate insert 48 will be described with reference to FIGS. 2 and 3. Mold gate insert 48 comprises a base structure or body portion 49 formed of a wear resistant and thermally highly conductive material, such as steel. As used herein, wear resistance includes both resistance to mechanical and corrosive wear. The base structure 49 defines part of the mold cavity 40 and a cavity for receiving the nozzle assembly 14. The base structure 49 of the mold gate insert 48 further includes a nozzle assembly alignment portion 53 for contacting and aligning the nozzle assembly 14 and is shaped to provide for the gate 44 for communication between the nozzle assembly 14 and the mold cavity 40. The mold gate insert 48 further comprises an insulation portion or heat dam 51. As can be best seen in FIG. 3, the material making up the heat dam 51 is completely embedded within the base structure 49 of the mold gate insert 48. In other words, no part of the heat dam 51 is exposed to the ambient environment outside of the mold gate insert 48. In order to maintain the nozzle tip 32 at its optimum operating temperature, the material forming the heat dam 51 has a relatively low thermal conductivity and is arranged within the base structure 49 of the mold gate insert 48 in close proximity to the nozzle assembly alignment portion 53 such that the heat flow between the nozzle assembly 14 and in particular the nozzle tip 32 thereof and the base structure 49 is impeded.

The heat dam 51 shown e.g. in the cross-sectional view of FIG. 2 essentially has the shape of a rectangle having rounded corners. In some embodiments of the present invention, the heat dam 51 is a ring shaped element that surrounds a periphery of the nozzle assembly alignment portion 53. The person skilled in the art, however, will appreciate that heat dams of virtually any shapes, such as circular, quadratic or the like. It will also be appreciated that the heat dam 51 does not need to be of uniform shape throughout its periphery. In alternative non-limiting embodiments of the present invention, the heat dam 51 does not need to surround the periphery of the nozzle assembly alignment portion 53 in its entirety and, as such, it may have one or more breaks, etc. Accordingly, the exact shape of the heat dam 51 is not meant to limit the scope of the present invention. It should be understood that the technical effects of the embodiments of the present invention can be achieved, as long as the heat dam 51 is essentially completely enclosed by the base structure 49 and arranged in close proximity to the nozzle assembly alignment portion 53 such that the heat flow between the nozzle assembly 14 and the base structure 49 is impeded.

Means for cooling, such as cooling channels 54, are typically provided in a mold cavity member 41 to cool the resin injected into mold cavity 40 and form a molded article 56, such as a preform. In the illustrated embodiment, a cooling fluid, such as water, is circulated through the cooling channels 54 during a cooling phase of an injection cycle, as will be further described below. In some embodiments of the present invention, also the mold gate insert 48 and more particular the base structure 49 thereof is provided with cooling means, such as cooling (a) channel(s) 58, through which a cooling fluid can be circulated. As can be best seen in FIGS. 2 and 3, these cooling channels 58 can be arranged close to the surface of the base structure 49 of the mold gate insert 48 contacting the molded article 56. These cooling channels 58 can be shaped to substantially conform to the contour of the surface of the base structure 49 of the mold gate insert 48 contacting the molded article 56. This has the effect that heat can be extracted more efficiently from the cooling molded article 56. Moreover, as is well known to those of skill in the art, further cooling of the molded article 56 is generally provided within a core 59 forming the interior surface of mold cavity 40.

As mentioned above the material forming the heat dam 51 has a relatively low thermal conductivity compared to the material of the base structure 49 of the mold gate insert 48. In a specific non-limiting embodiment of the present invention, a ceramic insulating material is used for forming the heat dam 51. However, it is also contemplated that other materials having similar characteristics can be used. In some embodiments of the present invention, the mold gate insert 48 including the base structure 49 and the completely embedded heat dam 51 according to embodiments of the present invention is produced by an investment casting process. The person skilled in the art is aware that conventional investment casting is a commonly used technique for forming metallic components having complex geometries, especially hollow components. In an investment casting process, a mold is prepared having a mold cavity with a shape generally corresponding to the part to be cast. For preparing the mold a wax model of the part is used. In a shelling process, a ceramic shell is formed around the wax model in a well known fashion. The shell may be fired to harden the shell. The wax may be removed such as by melting in an autoclave. Molten alloy may then be introduced to the mold to cast the part. Upon cooling and solidifying of the alloy, the shell may be mechanically and/or chemically removed from the molded part. The part can then be machined and/or treated in one or more stages.

According to embodiments of the present invention the model of the mold gate insert 48 to be cast is formed by molding wax over a piece of material, such as for example a ceramic material, having the shape of the heat dam 51 in the mold gate insert 48 to be cast. This results in a wax structure having the shape of the mold gate insert 48 to be cast and completely enclosing the heat dam 51. Alternatively, it is possible to form the model of the mold gate insert 48 to be cast, by molding a wax structure having the shape of the mold gate insert 48 or more particular the base structure 49 thereof. This wax structure could be molded either already with a cavity having the shape of the heat dam 51 or as a solid block of wax, which after the molding step is mechanically processed to provide for a cavity having the shape of the heat dam 51. This results in a wax structure having the shape of the mold gate insert 48 to be cast and a cavity having the shape of the heat dam 51.

Thereafter, the model of the mold gate insert 48 or more particular the base structure 49 thereof is coated with a ceramic shell, such as by dipping the model into a bath of liquefied ceramic material, and the ceramic shell is hardened, such as by baking. In the case where the wax structure has a cavity having the shape of the heat dam 51, the liquefied ceramic material will also fill the cavity having the shape of the heat dam 51 within the wax structure. Once the ceramic material is hardened, this results in a wax structure having the shape of the base structure 49 of the mold gate insert 48 to be cast, wherein the wax structure is covered by a ceramic shell and completely encloses the heat dam 51 of the mold gate insert 48 to be cast.

In a next step, the mold gate insert 48 is cast by introducing a highly thermally conductive material in molten form, such as steel, into the ceramic shell of the wax structure, thereby replacing the wax by the molten material, which, in turn, completely encloses the heat dam 51. Finally, the molten material within the ceramic shell is allowed to cool and solidify and the ceramic shell is removed, resulting in a mold gate insert 48 having a base structure 49 made of a highly thermal conductive material, such as steel, and a heat dam 51 made e.g. of ceramic material, wherein the heat dam 51 is completely enclosed by the base structure 49.

Alternatively, the wax could be removed first, such as by heating, and afterwards the molten material is cast into the mold provided by the ceramic shell. The person skilled in the art will appreciate that in this case the position of the heat dam 51 within the wax structure may have to be mechanically fixed with respect to the ceramic shell. This could be achieved, for instance, by means of small ceramic connections between the heat dam 51 and the ceramic shell. Although these small ceramic connections can be present in the mold gate insert 48, the heat dam 51 therein essentially is completely enclosed by the base structure 49 of the mold gate insert 48.

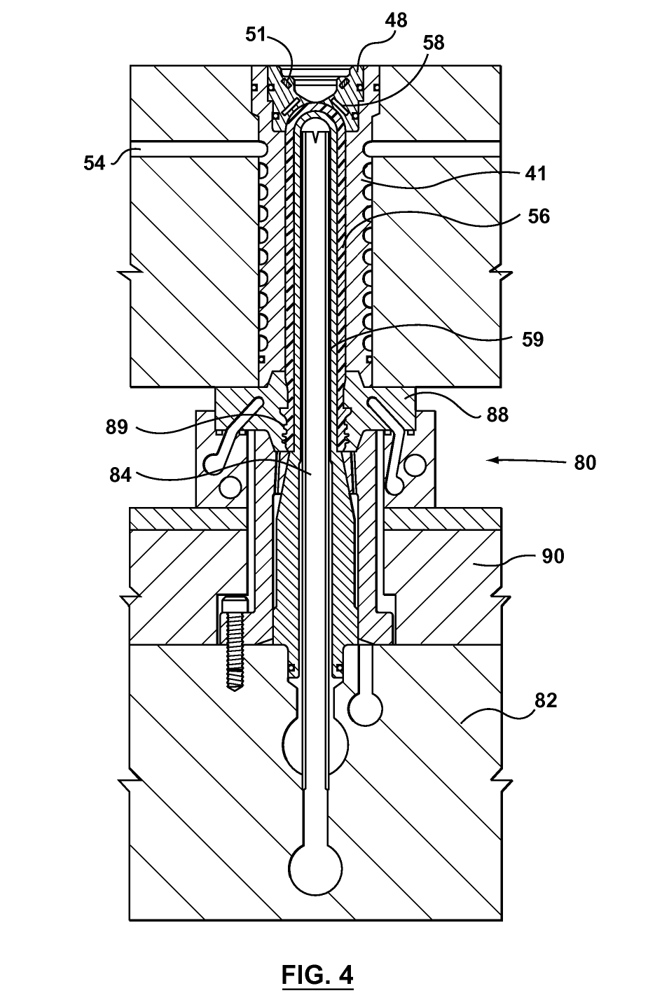

As the person skilled in the art will appreciate, the above described investment casting process according to embodiments of the present invention not only can be applied to the production of mold gate inserts. Rather, it is envisaged by the present invention that other elements of an injection molding machine where heat flow is an issue can be produced in accordance with the investment casting process of the present invention as well. For instance, a neck ring 88 of a mold assembly, such as shown in FIG. 4, could be produced according to the investment casting process of the present invention in order to consist of a thermally conductive and wear-resistant base structure and a thermally less conductive heat dam being completely enclosed by the base structure.

Generally, the mold gate insert 48 of the present invention will form part of a mold assembly 80, as shown in FIG. 4. The mold assembly 80 generally consists of mold cavity member 41 and mold core 59 cooperating to form mold cavity 40. Mold core 59 is mounted within a core plate 82 and is provided with a cooling tube 84 to cool the interior surface of a molded article 56. Mold gate insert 48 forms a section of the mold cavity 40. Gate 44 provides a passage for the flow of the resin into the mold cavity 40. Mold assembly 80 further includes a neck ring 88 that forms the threaded portion 89 of molded article 56, and some means to strip the finished frozen molded article 56 from the mold cavity 40. In the illustrated embodiment, stripping is achieved by a stripper plate 90 attached to neck ring 88. As the mold opens, stripper plate 90 moves away from the mold, retaining the molded article 56 within neck ring 88 from whence it can be ejected from the injection molding machine 10.

The operation of the present invention will now be described over the course of an injection cycle, with reference to FIGS. 1-4. In a typical injection cycle, valve stem 36 is retracted by piston 38 to open the gate 44. Resin, fed by the hot runner system 12 to nozzle channel 34, and hence to nozzle tip 32, is conveyed under pressure to mold cavity 40 through gate 44. Throughout the cycle, nozzle tip 32 is heated by nozzle heater bands 42 to maintain the resin in the nozzle channel 34 at an optimum processing temperature such that it is not subject to cyclic heating and cooling. As the resin is being conveyed into the mold cavity 40, the cooling channels 54, 58 provided in the mold cavity member 41 and the mold gate insert 48 are inactive thereby permitting the resin to fill the mold cavity 40 before beginning to freeze. Once the mold cavity 40 is filled, valve stem 36 is advanced to come to rest in gate 44 to stop the flow of resin. Simultaneously, the cooling channels 54, 58 are activated and the resin freezes to form molded article 56. The mold opens, the stripper plate 90 strips the molded article 56 from the mold, and ejects the finished molded article 56 from the injection molding machine 10. The mold then closes, and the cycle repeats.

During the cooling phase, when the cooling channels 54, 58 are activated, the relatively low thermal conductivity of the heat dam 51 of the mold gate insert 48 thermally shields the nozzle assembly 14 and in particular the nozzle tip 32 from the cooling provided to the mold cavity 40. When the gate 44 is closed, the wear resistant properties of the base structure 49 of the mold gate insert 48 prevent premature and unacceptable wear in the gate land area. Meanwhile, the relatively high thermal conductivity of the base structure 49 allows rapid cooling, when compared to the prior art, of adjacent portions of the mold cavity 40 during the cooling phase. Generally, the heat from these adjacent portions of the mold cavity 40 is dissipated to the circulating cooling fluid in cooling channels 58 and to the cavity plate 28. The more rapid cooling of the adjacent portions permits the total cycle time to be reduced without producing molded articles 56 with unacceptable defect levels.

The above description of the embodiments provides examples of the present invention, and these examples do not limit the scope of the present invention. It is understood that the scope of the present invention only is limited by the claims. The inventive concepts described above may be adapted for specific conditions and/or functions, and may be further extended to a variety of other applications that are within the scope of the present invention. While the present invention has been described with particular reference to the molding of PET preforms, it will be apparent that the gate insert of the present invention can be adapted for any injection molding machine requiring a gate insert. Having thus described the embodiments, it will be apparent that modifications and enhancements are possible without departing from the concepts as described. Therefore, what is to be protected is limited only by the scope of the following claims.

What is claimed is:

1. A mold gate insert, comprising:
a base structure formed of a wear resistant material having a first thermal conductivity and defining:
a mold cavity, at least in part;
a nozzle assembly alignment portion for aligning a nozzle assembly with respect to the base structure; and
a gate for communication between the mold cavity and the nozzle assembly; and
a heat dam being completely enclosed by the base structure;
wherein the heat dam is made of a material having a second thermal conductivity being less than the first thermal conductivity, and is arranged within the base structure in close proximity to the nozzle assembly alignment portion such that the heat flow between the nozzle assembly and the base structure is impeded.

2. The mold gate insert of claim 1, wherein the cross-section of the heat dam is one of substantially rectangular, circular and quadratic.

3. The mold gate insert of claim 1, wherein the base structure further defines a cooling channel within the base structure for cooling the mold cavity.

4. The mold gate insert of claim 3, wherein the shape of the cooling channel corresponds to the adjacent surface of the mold cavity.

5. The mold gate insert of anyone of the preceding claims, wherein the base structure is made from steel.

6. The mold gate insert of anyone of the preceding claims, wherein the heat dam is made from a ceramic material.

7. A heat dam disposed in a base structure of a mold gate insert for use in a molding system, the base structure having a first thermal conductivity, said heat dam comprising a body made of a material having a second thermal conductivity being less than the first thermal conductivity, said body being completely enclosed within the base structure in close proximity to a nozzle assembly alignment portion of the mold gate insert such that the heat flow between a nozzle assembly and the base structure is impeded.

8. A mold assembly for an injection molding machine, comprising:
a mold cavity;
a mold core cooperating with said mold cavity to form a molded article from molten plastic resin injected into said mold cavity during an injection cycle;
a gate for permitting flow of said resin from a nozzle tip into said mold cavity, said gate formed in a mold gate insert according to anyone of claims 1 to 6; and stripping means for stripping said molded article from said mold cavity.

9. An injection molding machine having a plurality of mold cavities for forming a plurality of molded articles during an injection cycle, comprising:
a source of molten plastic resin;
a plurality of nozzle assemblies, each said nozzle assembly having a nozzle channel for conveying said resin to a heated nozzle tip; and
a mold gate insert according to anyone of claims 1 to 6 adjacent each said nozzle assembly, said mold gate insert permitting communication between said nozzle assembly and its respective mold cavity.

10. An investment casting method for producing a mold gate insert including a base structure formed of a wear resistant first material having a first thermal conductivity and a heat dam being made of a second material having a second thermal conductivity being less than the first thermal conductivity, the method comprising:
providing a wax model of the base structure, wherein the second material of the heat dam is completely enclosed by the wax model of the base structure;
coating the wax model of the base structure with a ceramic shell;
hardening the ceramic shell of the wax model of the base structure;
replacing the wax of the wax model of the base structure within the ceramic shell by the molten first material, which thereby completely encloses the second material of the heat dam; and
solidifying the molten first material within the ceramic shell of the base structure and removing the ceramic shell.

11. The investment casting method of claim 10, wherein the wax of the wax model of the base structure within the ceramic shell is replaced by the molten first material by casting the molten first material into the ceramic shell of the wax model of the base structure and thereby melting and removing the wax of the wax model of the base structure within the ceramic shell.

12. The investment casting method of claim 10, wherein the wax of the wax model of the base structure within the ceramic shell is replaced by the molten first material by removing the wax of the wax model of the base structure within the ceramic shell and thereafter casting the molten first material into the ceramic shell.

13. The investment casting method of anyone of claims 10 to 12, wherein the wax model of the base structure completely enclosing the second material of the heat dam is provided by molding wax over a piece of material having the shape of the heat dam.

14. The investment casting method of anyone of claims 10 to 12, wherein the wax model of the base structure completely enclosing the second material of the heat dam is provided by molding a wax structure, having the shape of the base structure and a cavity having the shape of the heat dam.

15. The investment casting method of anyone of claims 10 to 12, wherein the wax model of the base structure completely enclosing the second material of the heat dam is provided by molding a wax structure having the shape of the base structure as a solid block and, thereafter, mechanically processing said solid block to provide for a cavity having the shape of the heat dam.

16. A method for producing a mold assembly element including a base structure formed of a wear resistant first material having a first thermal conductivity and a heat dam being made of a second material having a second thermal conductivity being less than the first thermal conductivity, the method comprising:
providing a wax model of the base structure, wherein the second material of the heat dam is completely enclosed by the wax model of the base structure;
coating the wax model of the base structure with a ceramic shell;
hardening the ceramic shell of the wax model of the base structure;
replacing the wax of the wax model of the base structure within the ceramic shell by the molten first material, which thereby completely encloses the second material of the heat dam; and
solidifying the molten first material within the ceramic shell of the base structure and removing the ceramic shell.
